(19) United States
(12) Patent Application Publication
(10) Pub. No.: US 2014/0327937 A1
(43) Pub. Date: Nov. 6, 2014

(54) MICROFORMAT FOR UNIFIED PRINTING OF WEB CONTENT

(71) Applicant: HEWLETT-PACKARD DEVELOPMENT COMPANY, L.P., Fort Collins, CO (US)

(72) Inventors: Venugopal K. Srinivasmurthy, Bangalore (IN); Bibhu Prasad Biswal, Bangalore (IN)

(73) Assignee: Hewlett-Packard Development Company, L.P., Fort Collins, CO (US)

(21) Appl. No.: 13/887,080

(22) Filed: May 3, 2013

(51) Int. Cl. G06K 15/02

(52) U.S. Cl. CPC G06K 15/181
USPC 358/1.18

(57) ABSTRACT

Example embodiments relate to a microformat for unified printing of web content. In example embodiments, a system obtains web content that is displayed in a web browser, where the web content includes meta tags that specify print property assertions and print property intents. The system processes the print property assertions to determine printing device capabilities that are compatible with the web content and identifies printing devices that satisfy the printing device capabilities. At this stage, the system processes the print property intents to determine a print layout of the web content and sends a print job for the web content to one of the printing devices, where the print job is generated based on the print layout of the web content.

### BACKGROUND

Typically, web content is an amalgamation of structured and unstructured documents such as hypertext markup language (HTML) with embedded images. Unstructured and dynamic web content is printed from web browsers haphazardly without appropriate print formatting. A user may manually apply a print format by copying the web content into a standalone application such as a word processor and then formatting the web content for printing.

### BRIEF DESCRIPTION OF THE DRAWINGS

The following detailed description references the drawings, wherein:

FIG. 1 is a block diagram of an example computing device for providing a microformat for unified printing of web content;

FIG. 2 is a block diagram of an example computing device in communication with web content servers and printing devices for providing a microformat for unified printing of web content;

FIG. 3 is a flowchart of an example method for execution by a computing device for unified printing of web content using a microformat;

FIG. 4 is a flowchart of an example method for execution by a computing device for printer discovery and unified printing of web content using a microformat;

FIG. 5 is a diagram of meta tags of a microformat for unified printing of web content; and

FIGS. 6A-6B are diagrams of an example user interface of a web browser in which web content is displayed for printing.

### DETAILED DESCRIPTION

As detailed above, web browsers allow users to print web content with little or no print formatting. For example, web content may be wrapped and proportionally resized to fit the page size of the printer. In some cases, web content may be re-rendered in a more print friendly format in a separate web page by the web content provider. However, the separate web page is only available if provided by the content provider and does not allow the user to control the formatting of the web content.

Example embodiments disclosed herein provide a microformat for unified printing of web content. For example, in some embodiments, a computing device obtains web content that is displayed in a web browser, where the web content includes meta tags that specify print property assertions and print property intents. The computing device processes the print property assertions to determine printing device capabilities that are compatible with the web content and identifies printing devices that satisfy the printing device capabilities. At this stage, the computing device processes the print property intents to determine a print layout of the web content and sends a print job for the web content to one of the printing devices, where the print job is generated based on the print layout of the web content.

In this manner, example embodiments disclosed herein improve the printing function of web browsers by providing a microformat for defining print attributes and formatting. Specifically, by providing the microformat, portions of web content may be designated with print attributes such as printability and formatting, which allow the web browser to provide a customizable printing experience for the user.

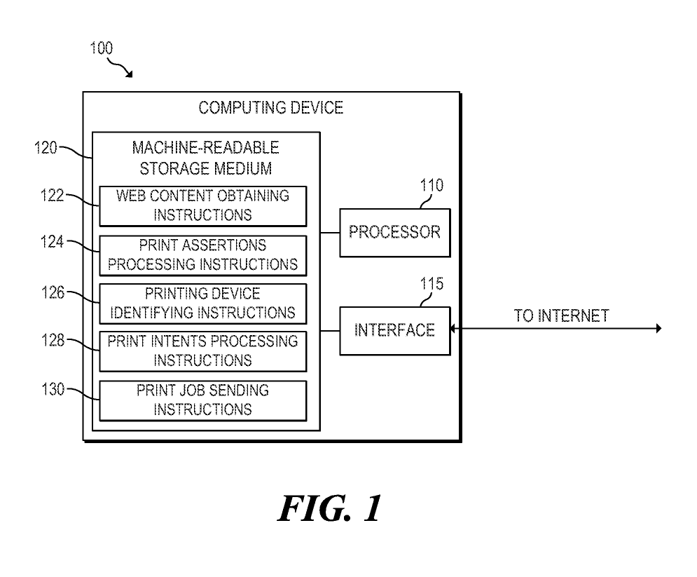

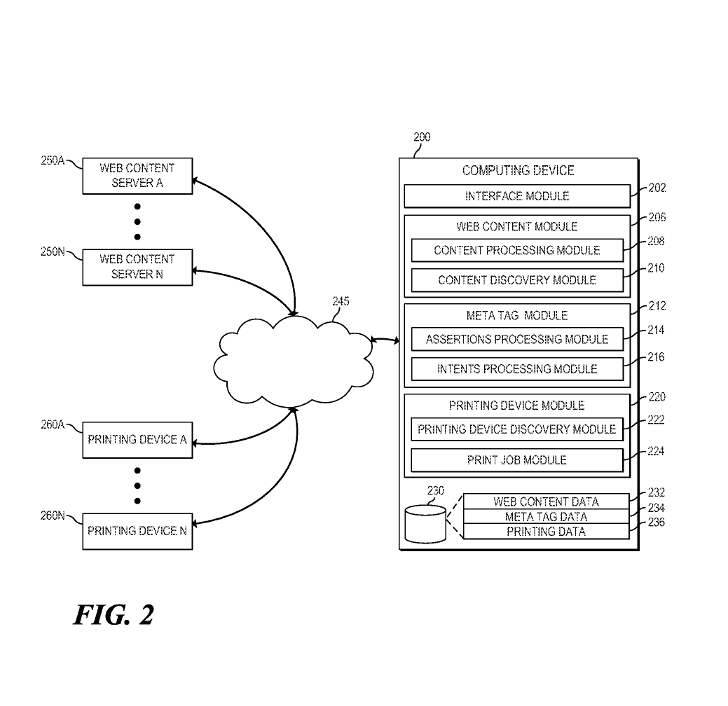

Referring now to the drawings, FIG. 1 is a block diagram of an example computing device 100 for providing a microformat for unified printing of web content. Computing device 100 may be any computing device (e.g., smartphone, tablet, laptop computer, desktop computer, etc.) capable of accessing a cloud server, such as cloud server 200 of FIG. 2. In the embodiment of FIG. 1, server computing device 100 includes a processor 110, an interface 115, and a machine-readable storage medium 120.

Processor 110 may be one or more central processing units (CPUs), microprocessors, and/or other hardware devices suitable for retrieval and execution of instructions stored in machine-readable storage medium 120. Processor 110 may fetch, decode, and execute instructions 122, 124, 126, 128, 130 to enable unified printing of web content using a microformat, as described below. As an alternative or in addition to retrieving and executing instructions, processor 110 may include one or more electronic circuits comprising a number of electronic components for performing the functionality of one or more of instructions 122, 124, 126, 128, 130.

Interface 115 may include a number of electronic components for communicating with printing devices and web content servers. For example, interface 115 may be an Ethernet interface, a Universal Serial Bus (USB) interface, an IEEE 1394 (Firewire) interface, an external Serial Advanced Technology Attachment (eSATA) interface, or any other physical connection interface suitable for communication with the user computing device. Alternatively, interface 115 may be a wireless interface, such as a wireless local area network (WLAN) interface or a near-field communication (NFC) interface. In operation, as detailed below, interface 115 may be used to send and receive data, such as web content data, meta tag data, and printing data, to and from a corresponding interface of a user computing device.

Machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. As described in detail below, machine-readable storage medium 120 may be encoded with executable instructions for providing a microformat for unified printing of web content.

Web content obtaining instructions 122 may obtain web content displayed in a web browser. The web browser may be executing on computing device 100 to provide the web content to a user. In this case, the web browser receives the web content via interface 115 from a web content server. The web content may be a web page that is provided as HTML or some other markup language (e.g., extensible markup language (XML), extensible hypertext markup language (XHTML)) to computing device 100 and then rendered for display in the web browser. Web content obtaining instructions 122 may obtain the web content from the web browser for processing as discussed below.

The web content may include meta tags of a microformat that define print capabilities including assertions and intents. Print property assertions may assert a set of searchable printing characteristics (e.g., print quality, orientation, description, color, etc.) for portions of the web content such as images or printable documents. Print property intents may describe the formatting attributes (e.g., resolution; media size, format, etc.) of portions of the web content that allow print service discovery and templates to be applied to the web content. For example, the format tag allows the computing device 100 to identify templates that may be applied to the web content (e.g., a grid template may be applied to images from a web page).

A microformat is a web-based technique for descriptive markup that reuses and expands on existing markup tags to convey metadata and other attributes in web content. The reuse of existing markup tags allows computing device 100 to process data within an existing annotation framework that is not intended to be displayed for users. Traditional markup tags are not self-descriptive like meta tags in a microformat. Descriptive meta tags allow portions of web content to be indexed for searching.

Print assertions processing instructions 124 may process print property intents in web content to determine the target printing device capabilities of portions (e.g., image, paragraph, printable document, etc.) of the web content. Portions of the web content with print property assertions may be identified as printable portions. Conversely, portions of the web content without print property assertions may be identified as unprintable portions. Further, the target printing device capabilities are used to discover printing devices that are compatible with the designated portions of the web content.

Printing device identifying instructions 126 may use the determined target printing device capabilities to identify printing devices for printing the web content. Both local printing devices and cloud printing devices may be searched to identify printing devices that satisfy the target printing device capabilities. For example, if a print property assertion specifies that the portion of the web document is in color, printing devices that support color printing may be identified.

Print intents processing instructions 128 may process print property intents in web content to determine formatting attributes of portions of the web content. The formatting attributes may be used to generate a print job for the portions of the web content to be printed. For example, the format print property intents may specify the format of each portion of the web content as, for example, image, portable document format (PDF), or hypertext markup language (HTML). Print intents processing instructions 128 may identify templates that can be applied to the portions of the web content based on the format of each portion.

Print job sending instructions 130 may send a print job including portions of the web content to a printing device selected by the user. Further, the portions included in the print job may be selected by the user based on print property assertions. For example, the user may select all images in the web content for the print job.

FIG. 2 is a block diagram of an example computing device 200 in communication via a network 245 with web content servers (e.g., web content server A 250A, web content server N 250N) and printing devices (e.g., printing device A 260A, printing device N 260N). As illustrated in FIG. 2 and described below, computing device 200 may communicate with web content servers and printing devices to provide a microformat for unified printing of web content.

As illustrated, computing device 200 may include a number of modules 202-224. Each of the modules may include a series of instructions encoded on a machine-readable storage medium and executable by a processor of the computing device 200. In addition or as an alternative, each module may include one or more hardware devices including electronic circuitry for implementing the functionality described below.

As with computing device 100 of FIG. 1, computing device 200 may be a notebook, desktop, tablet, workstation, mobile device, or any other device suitable for executing the functionality described below. As detailed below, computing device 200 may include a series of modifies 202-224 for enabling the processing of meta tags of a microformat for unified printing.

Interface module 202 may manage communications with the web content servers (e.g., web content server A 250A, web content server N 250N) and the printing devices (e.g., printing device A 260A, printing device N 260N). Specifically, the interface module 202 may (1) initiate connections with the web content servers and then send or receive web content data 232 to/from the web content servers and (2) initiate connections with the printing devices and then send or receive printing data 236 to/from the printing devices.

Web content module 206 may provide a user with access web content from the web content servers (e.g., web content server A 250A, web content server N 250N). Although the components of web content module 206 are described in detail below, additional details regarding an example implementation of module 206 are provided above in connection with instructions 122 of FIG. 1.

Content processing module 208 may process web content from the web content servers (e.g., web content server A 250A, web content server N 250N). Initially, content processing module 208 may process the web content to be displayed in a web browser for the user. If the user initiates a print job of the web content, content processing module 208 may obtain meta tags and corresponding portions of the web content for further processing by the meta tag module 212.

Content discovery module 210 may perform searches for printable web content provided by the web content servers (e.g., web content server A 250A, web content server N 250N). Specifically, the search may identify printable web content that satisfies printing device capabilities as specified by print property assertions. In some cases, the printable web content on the web content servers (e.g., web content server A 250A, web content server N 250N) may be indexed by a searching service so that searches may be performed according to printing device capabilities.

Meta tag module 212 may process meta tags from web content to determine print capabilities of the web content. Although the components of meta tag module 212 are described in detail below, additional details regarding an example implementation of module 212 are provided above in connection with instructions 124-128 of FIG. 1.

Assertions processing module 214 may process print property assertions from web content. Specifically, the print property assertions may be processed to determine the target printing device capabilities of portions of the web content. Potential values for print property assertions may be stored as meta tag data 234 in storage device 230. Once determined, the target printing device capabilities may be provided to printing device module 220 for printer discovery.

Intents processing module 216 may processing print property intents from web content. Specifically, the print property intents may be processed to determine formatting characteristics of portions of the web content. Potential values and descriptions of the print property intents may be stored as meta tag data 234 in storage device 230. Once determined, the formatting characteristics of the portions of the web content may be provided to printing device module 220 for generating print jobs.

Printing device module 220 may process print jobs of web content. Although the components of printing device module 220 are described in detail below, additional details regarding an example implementation of module 220 are provided above in connection with instructions 130 of FIG. 1.

Printing device discovery module 222 may discover printing devices that satisfy target printing device capabilities. Specifically, discovery may be performed to discover local, networked, or cloud printing devices that satisfy the capabilities. Printing device discovery module 222 may provide a user interface that allows the user to select one of the discovered printing devices. In some cases, the target printing device capabilities are used a default values in the user interface. The user may modify the default values to search for printing devices with different capabilities (e.g., the user may select to search for black & white printers instead of color printers). Discovered printers and corresponding settings may be stored as printing data 236 in storage device 230.

Print job module 224 may generate print jobs based on formatting characteristics of portions of the web content. The portions of web content may be selected by the user via a web interface that is provided by the print job module 224. For example, print job module 224 may display a list of printable portions of the web content, where the user may select portions for including in a print job. After the portions are selected, print job module 224 may allow the user to select a formatting template for applying to the selected portions of the web content. Once the portions and templates are selected, print job module 224 may generate a print job for sending to a selected printing device.

Storage device 230 may be any hardware storage device for maintaining data accessible to computing device 200. For example, storage device 230 may include one or more hard disk drives, solid state drives, tape drives, and/or any other storage devices. The storage devices may be located in computing device 200 and/or in another device in communication with computing device 200. As detailed above, storage device 230 may maintain web content data 232, meta tag data 234, and printing data 236.

Web content servers (e.g., web content server A 250A, web content server N 250N) may be any server accessible to computing device 200 over the network 245 that is suitable for providing web content. Web content servers (e.g., web content server A 250A, web content server N 250N) may provide web content as HTML that includes meta tags for defining print capabilities.

Printing devices (e.g., printing device A 260A, printing device N 260N) may be local, networked, or cloud printing devices accessible to computing device 200 via the network 245. Each printing device (e.g., printing device A 260A, printing device N 260N) may be, for example, an inkjet printer, a laser printer, a solid printing fluid printer, an all-in-one printer, a snapshot printer, or any other printing device suitable for processing print jobs from computing device 200.

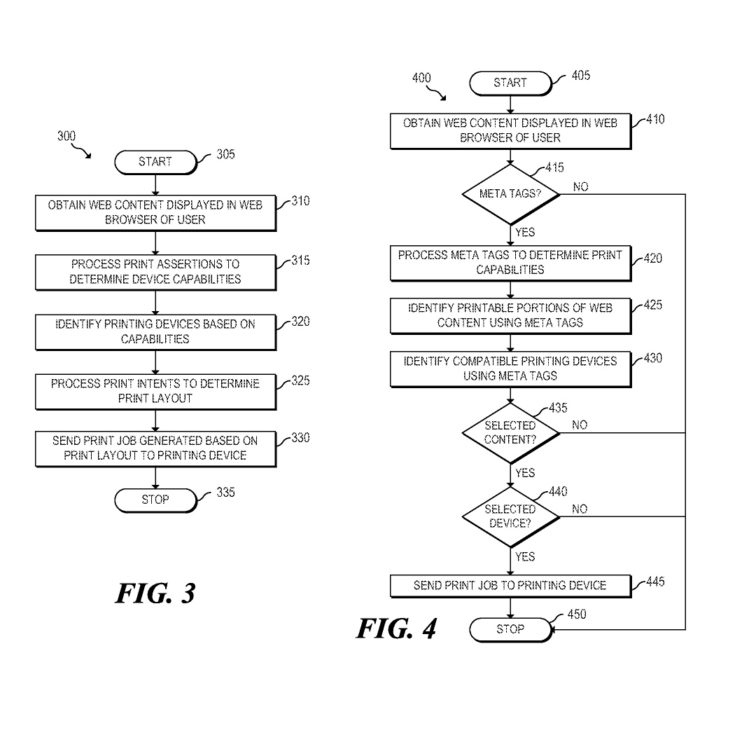

FIG. 3 is a flowchart of an example method 300 for execution by a computing device 100 for providing a microformat for unified printing of web content. Although execution of method 300 is described below with reference to computing device 100 of FIG. 1, other suitable devices for execution of method 300 may be used, such as computing device 200 of FIG. 2. Method 300 may be implemented in the form of executable instructions stored on a machine-readable storage medium, such as storage medium 120, and/or in the form of electronic circuitry.

Method 300 may start in block 305 and continue to block 310, where computing device 100 obtains web content displayed in a web browser of a user. The web content may be obtained in response to the user initiating a print plugin in the web browser. In block 315, meta tags defining print property assertions may be processed to determine target printing device capabilities. At this stage, printing devices that satisfy the target printing device capabilities may be identified in block 320. Computing device 100 may display a user interface allowing the user to modify the target printing device capabilities and select one of the identified printing devices.

In block 325, meta tags defining print property intents may be processed to determine formatting characteristics of portions of the web content. Computing device 100 may provide a user interface that allows the user to select portions of the web content for printing. The user interface may use the print property intents to display a title and other information for each portion of the web content, which assist the user in his selection. After the portions are selected, computing device 100 may allow a user to select a template to apply a print layout to the selected portions of the web content. For example, the print layout may specify the format (e.g., PDF, HTML, image, etc.) and print locations, target location for a printed portion of the web content, of the selected portions of the web content. The print locations may be determined based on characteristics such as content resolution and a selected template. In block 330, a print job is generated based on the selected portions and print layout and sent to the printing device that was selected by the user. Method 300 may then continue to block 335, where method 300 may stop.

FIG. 4 is a flowchart of an example method 400 for execution by a computing device 100 for printer discovery and unified printing of web content using a microformat. Although execution of method 400 is described below with reference to computing device 100 of FIG. 1, other suitable devices for execution of method 400 may be used, such as computing device 200 of FIG. 2. Method 400 may be implemented in the form of executable instructions stored on a machine-readable storage medium, such as storage medium 120, and/or in the form of electronic circuitry.

Method 400 may start in block 405 and continue to block 410, where computing device 100 may obtain web content displayed in a web browser of user. The web content may be obtained in response to the user initiating a print plugin of the web browser. In block 415, computing device 100 determines if there are meta tags in the web content. If there are no meta tags in the web content, computing device 100 may notify the user of the lack of meta tags, and method 400 may then proceed to block 450, where method 400 may stop.

If there are meta tags in the web content, computing device 100 processes the meta tags to determine print capabilities of the web content in block 420. Specifically, print property assertions and intents may be processed as discussed above. In block 425, printable portions of the web content may be identified using the meta tags. In block 430, compatible printing devices for printing the web content may be identified using the print property assertions. Computing device 100 may allow the user to select portions for printing and then select a printer for receiving the print job.

In block 435, computing device 100 determines if the user has selected content for printing. If no content is selected for printing, method 400 may then proceed to block 450, where method 400 may stop. If content is selected, computing device 100 determines if the user has selected a printing device in block 440. If no printing device is selected, method 400 may then proceed to block 450, where method 400 may stop.

If a printing device is selected, a print job for the selected portions of the web content is sent to the selected printer in block 445. Method 400 may then continue to block 450, where method 400 may stop.

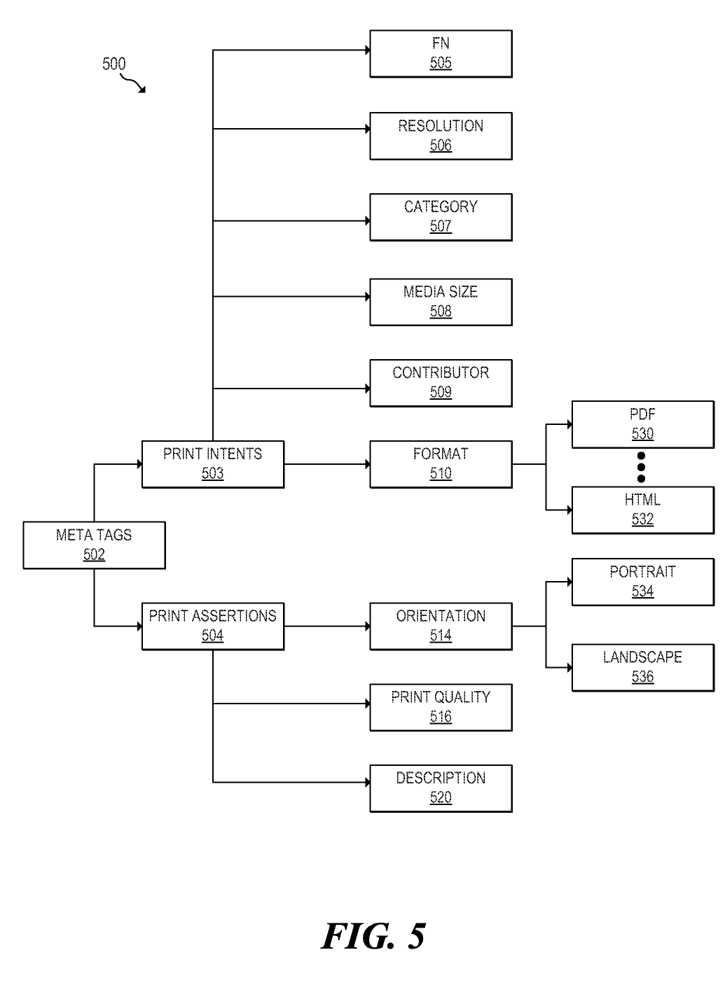

FIG. 5 is a diagram of meta tags 502 of a microformat 500 for unified printing of web content. The meta tags 502 may include print property intents 503 and print property assertions 504. The print property intents 503 may include an FN property 505, a resolution property 506, a category property 507, a media size property 508, a contributor property 509, and a format property 510. The FN property 505 may be a short title describing the corresponding portion of the web content. The resolution property 506 may, if applicable, define the resolution of the corresponding portion of the web content. The category property 507 may define the portion of the web content as a member of predetermined categories of content. The media size property 508 may, if applicable, define the stored size of the corresponding portion of the web content. The contributor property 509 may describe a contributor that created the corresponding portion of the web content. The format property 510 may describe the format of the corresponding portion of the web content. Examples of values for the format property 510 are a portable document file (PDF) format 530 and an HTML format 532. The print property assertions 504 may be used to define the print format of portions of the web content or to generate search indexes for discovering web content.

Examples of categories for the category property 507 include business profile, game, wiki entry, photo album, etc. Each category may have a default template that is applied to web content that belongs to the category.

The print property assertions 504 may include an orientation property 514, a print quality property 516, and a description property 518. The orientation property 514 may define the orientation of a portion of the web content as either portrait 534 or landscape 536. The print quality property 516 may define a print quality (e.g., dots per inch) of a portion of the web content. The description property 518 may be a human-readable description of a portion of the web content. The print property assertions 504 may be used to specify target printing device capabilities that can be used for printer discovery.

An example of meta tags 502 in web content is shown below in TABLE 1

TABLE 1
Example meta tags in web content

```
<div class=“hprint”>
  Enjoy Fun Printing activies
  <span class=“fn”>Fun Game</span>, a
  <span class=“category”>game</span> by
  <span class=“contributor”>
    <span class=“vcard”>
      <span class=“fn n”>
        <span class=“given-name”>Toy Company</span>
      </span>
    </span>
  </span>
  <span class=“format”>PDF</span>
  <span class=“orientation”>portrait</span>
  <span olass=“printquality”>Normal</span>
</div>
```

The example in TABLE 1 shows a portion of web content with a short title of “Fun Game”, a category of “game”, a contributor of “Toy Company”, a format of “PDF”, an orientation of “portrait”, and a print quality of “Normal”. The print property assertions in TABLE 1 may be used in searches to discover the portion of the web content.

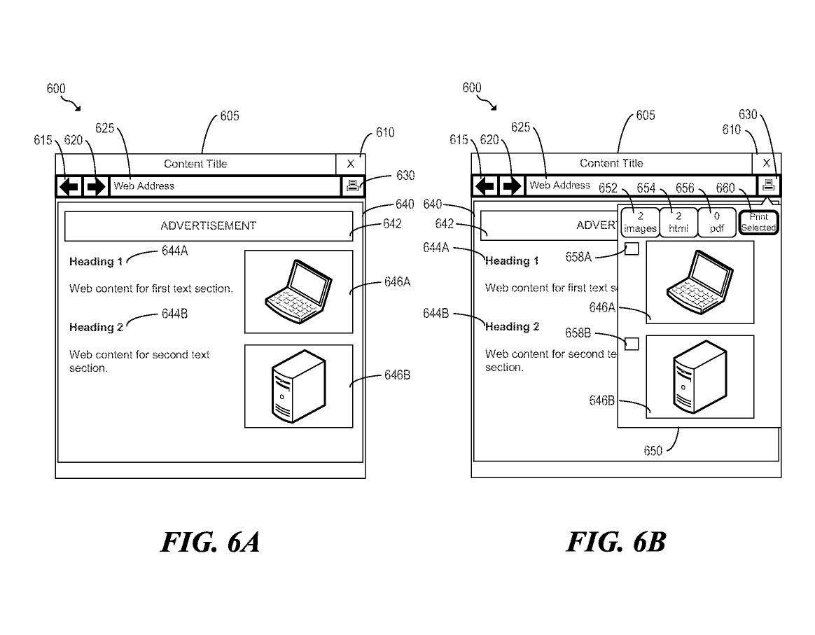

FIGS. 6A-6B are diagrams of an example user interface 600 of a web browser in which web content is displayed in panel 640 for printing. As depicted, the user interface 600 includes a title bar 605 identifying the web content and a close icon 610 that may be used by the user to exit the web browser. The user interface 600 also includes menus a back navigation button 615, a forward navigation button 620, a web address input box 625, and a print plugin button 630.

The user interface 600 has outputted the web content in the panel 640. In FIG. 6A, an advertisement 642 is shown at the top of the panel 640, HTML content A 644A and HTML content B 644B are shown on the left side of the panel 640, and image A 646A and image B 646B are shown on the fight side of the panel 640. The web content shown in panel 640 may be rendered from underlying HTML that includes meta tags. In this example, the meta tags may specify advertisement 642 as unprintable and HTML content A 644A, HTML content B 644B, image A 646A, and image B 646B as printable. In response to the user selecting the print plugin button 630, the user interface 600 may be updated as shown in FIG. 6B.

In FIG. 6B, the panel 640 now includes a print plugin interface 650. The print plugin interface 650 allows the user to select printable portions of the web content for printing. The print plugin interface 650 includes a printable images tab 652, a printable HTML tab 654, and a printable PDF tab 656. The printable tabs show the quantity of printable portions in each format category. In FIG. 6B, the printable images tab 652 is selected so that image A 646A and image B 646B is shown with an associated selection box 658A, 658B. The user may use the selection boxes to select images for printing. After the selections are complete, the user may select a print selected button 660 to initiate a print job that includes the selected images.

The foregoing disclosure describes a number of example embodiments for providing a microformat for unified printing of web content by a computing device. In this manner, the embodiments disclosed herein enable unified printing for web content by providing a microformat that allows printing capabilities to be defined in existing markup tags.

We claim:

1. A system for providing a microformat for unified printing of web-based content, the system comprising:
a processor to:
obtain web content that is displayed in a web browser, wherein the web content comprises meta tags that include a plurality of print property assertions and a plurality of print property intents;
process the plurality of print property assertions to determine printing device capabilities that are compatible with the web content;
identify a plurality of printing devices that satisfy the printing device capabilities;
process the plurality of print property intents to determine a print layout of the web content; and
send a print job for the web content to one of the plurality of printing devices, wherein the print job is generated based on the print layout of the web content.

2. The system of claim 1, wherein at least one of the plurality of print property intents identifies printable portions of the web content, and wherein the print job comprises at least one of the printable portions.

3. The system of claim 1, wherein the plurality of print property intents is indexed for a web content search service, and wherein the processor is further configured to:
identify a plurality of printable web content based on search criteria specified by a user, wherein the web content of the plurality of web content satisfies the search criteria based on at least one of the plurality of print property intents.

4. The system of claim 1, wherein the plurality of print property intents comprises a format property, and wherein the processor is further configured to:
identify a plurality of templates based on a format value of the format property that are compatible with the web content; and
apply, in response to a user selecting a template of the plurality of templates, the template to the web content to determine the print layout.

5. The system of claim 1, wherein the plurality of print property assertions and the plurality of print property intents are embedded in hypertext markup language (HTML) tags.

6. The system of claim 1, wherein the web content is obtained in response to a user initiating a print plugin in the web browser.

7. A method for providing a microformat for unified printing of web-based content, the method comprising:
obtaining web content that is displayed in a web browser, wherein the web content comprises meta tags that include a plurality of print property assertions and a plurality of print property intents;
processing the plurality of print property assertions to determine printing device capabilities that are compatible with the web content;
identifying a plurality of printing devices that satisfy the printing device capabilities;
processing the plurality of print property intents to determine a print layout of the web content, wherein at least one of the plurality of print property intents identifies printable portions of the web content; and
sending a print job for the web content to one of the plurality of printing devices, wherein the print job is generated based on the print layout of the web content and comprises at least one of the printable portions.

8. The method of claim 7, wherein the plurality of print property intents is indexed for a web content search service, and wherein the method further comprises:
identifying a plurality of printable web content based on search criteria specified by a user, wherein the web content of the plurality of web content satisfies the search criteria based on at least one of the plurality of print property intents.

9. The method of claim 7, wherein the plurality of print property intents comprises a format property, and wherein the method further comprises:
identifying a plurality of templates based on a format value of the format property that are compatible with the web content; and
in response to a user selecting a template of the plurality of templates, applying the template to the web content to determine the print layout.

10. The method of claim 7, wherein the plurality of print property assertions and the plurality of print property intents are embedded in hypertext markup language (HTML) tags.

11. The method of claim 7, wherein the web content is obtained in response to a user initiating a print plugin in the web browser.

12. A non-transitory machine-readable storage medium encoded with instructions executable by a processor, the machine-readable storage medium comprising:
instructions to obtain web content that is displayed in a web browser, wherein the web content comprises a plurality of print property assertions and a plurality of print property intents that are embedded in hypertext markup language (HTML) tags;
instructions to process the plurality of print property assertions to determine printing device capabilities that are compatible with the web content;
instructions to identify a plurality of printing devices that satisfy the printing device capabilities;
instructions to process the plurality of print property intents to determine a print layout of the web content; and
instructions to send a print job for the web content to one of the plurality of printing devices, wherein the print job is generated based on the print layout of the web content.

13. The machine-readable storage medium of claim 12, wherein at least one of the plurality of print property intents identifies printable portions of the web content, and wherein the print job comprises at least one of the printable portions.

14. The machine-readable storage medium of claim 12, wherein the plurality of print property intents is indexed for a web content search service, and wherein the machine-readable storage medium further comprises instructions to:
identify a plurality of printable web content based on search criteria specified by a user, wherein the web content of the plurality of web content satisfies the search criteria based on at least one of the plurality of print property intents.

15. The machine-readable storage medium of claim 12, wherein the plurality of print property intents comprises a format property, and wherein the machine-readable storage medium further comprises instructions to:
identify a plurality of templates based on a format value of the format property that are compatible with the web content; and
apply, in response to a user selecting a template of the plurality of templates, the template to the web content to determine the print layout.
